(19) United States
(12) Patent Application Publication
(10) Pub. No.: US 2014/0262651 A1
(43) Pub. Date: Sep. 18, 2014

(54) SHOCK ABSORBER FOR A VEHICLE HAVING A LIGHTWEIGHT DESIGN

(71) Applicant: Hanno Luczak, Hattingen (DE)

(72) Inventor: Hanno Luczak, Hattingen (DE)

(73) Assignee: THYSSENKRUPP BILSTEIN GMBH, ENNEPETAL (DE)

(21) Appl. No.: 14/237,018

(22) PCT Filed: Aug. 1, 2012
(86) PCT No.: PCT/EP2012/065076

§ 371 Date: Mar. 28, 2014

(30) Foreign Application Priority Data
Aug. 4, 2011 (DE) 102011109362.5

(51) Int. Cl. B60G 13/06

(52) U.S. Cl. CPC B60G 13/06; B60G 2202/24; B60G 2206/41
USPC 188/297; 29/896.93; 188/322.19; 156/184

(57) ABSTRACT

A shock absorber for a vehicle contains a shock absorber tube in which at least one shock absorber piston is guided in a sliding manner. The shock absorber tube is made of a carbon fiber composite material and has a coating made of an epoxide on the inside of the shock absorber tube, which coating forms the sliding partner for the shock absorber piston guided in the shock absorber tube. A method is explained for producing the shock absorber tube for the shock absorber and to the use of a tube made of a carbon fiber composite material having an epoxide coating to form a shock absorber tube for a shock absorber.

The present invention relates to a shock absorber for a vehicle with a shock absorber tube, in which at least one shock absorber piston is guided in a sliding manner, wherein the shock absorber tube is made of a carbon fiber composite material. The invention is further geared toward the use of a tube made of a carbon fiber composite material to form a shock absorber tube for a shock absorber, as wells toward a method for manufacturing a shock absorber tube for a shock absorber.

Known from DE 100 03 046 A1 is a shock absorber that can be used for a vehicle, and the shock absorber features a shock absorber tube made of an aluminum material. Placed inside the tube made of aluminum is a thin-walled sleeve, which is permanently connected with the aluminum tube with the latter being molded in a process running essentially in the radial direction. This is intended to reduce the weight of the shock absorber by not manufacturing the shock absorber tube completely out of a steel material. Only the thin-walled sleeve is designed as a steel sleeve, and the basic structure of the shock absorber is made of an aluminum material. However, the disadvantage is that the overall weight of the shock absorber remains high even then if the shock absorber tube is manufactured out of metallic materials.

Known from DE 103 13 477 B3 is a cylindrical tube for a working cylinder, and the cylindrical tube features an inner tube comprised of thermoplastic, and a coaxially arranged outer tube that envelops the inner tube and is made of a fiber-reinforced thermoplastic. For example, this fiber-reinforced plastic can be a carbon fiber composite material.

However, a further development of the depicted working cylinder geared toward qualifying it for use as a shock absorber tube for the shock absorber of a vehicle is not indicated in conjunction with the disclosed working cylinder.

FR 2 473 961 A1 deals with a cylindrical tube for a shock absorber fabricated out of a carbon fiber composite material. This makes it possible to reduce the weight of the shock absorber, since a carbon fiber composite material is lighter by comparison to a metallic material, in particular steel. However, there are disadvantages with regard to the inner sliding surface as a sliding partner, e.g., for the shock absorber piston, and it is known that the diameter of tubes made of carbon fiber composite material changes with a varying internal pressures, a process referred to as breathing, so that conventional anti-friction coatings on the inner sliding surface are not suitable.

Therefore, the object of the present invention is to provide a shock absorber for a vehicle having a lightweight design, which can still satisfy the requirements during vehicle operation, even though a light material is used.

This object is achieved proceeding from a shock absorber for a vehicle with a shock absorber tube according to the preamble to claim 1 in conjunction with the characterizing features. Advantageous further developments of the invention are indicated in the dependent claims.

The invention comprises the technical teaching, that the inside of the shock absorber tube features a coating, which forms the sliding partner for the shock absorber piston guided in the shock absorber tube, wherein the coating is comprised of an epoxide.

The invention is here based on the idea of taking the base body of a shock absorber tube made of a carbon fiber composite material and simultaneously providing it with a coating on the inside of the shock absorber tube that is durable and forms the sliding partner of the shock absorber piston. As a consequence, the shock absorber tube can be assembled without metallic components, so that the weight of the shock absorber tube can be further reduced by comparison to an embodiment comprised of an aluminum base body and a steel sleeve. The coating on the inside of the shock absorber tube prevents the carbon fiber composite material with its fiber component from already forming the sliding partner for guiding the shock absorber piston in a sliding manner, since the sliding pair generated in this way might become damaged given contact between the movable shock absorber piston and the fiber component of the carbon fiber material.

The ends of the shock absorber tube are sealed by sealing elements, for example against a fastening element or connecting element, and the coating here simultaneously yields the contact surface of the sealing elements. Several shock absorber pistons can be guided in a sliding manner in the shock absorber tube, for example so that a first shock absorber piston can consist of a plunger having situated on it a piston rod, while another shock absorber piston can take the form of a separating piston, so as to movably separate a first fluid chamber from a second fluid chamber. All elements movably guided in the shock absorber, in particular all pistons; can here slide over the coating on the inside of the shock absorber tube.

According to the invention, the coating on the inside of the shock absorber tube can feature a nonmetallic coating by having it consist of an epoxide. In another advantage, the carbon fiber composite material can feature a matrix comprised of epoxide, wherein the epoxide that forms the coating is in particular identical or similar to the epoxide that forms the matrix, and wherein in particular the carbon fiber composite material can feature a 60% volumetric fraction of fiber.

As a consequence, a carbon fiber composite material forms over the wall thickness of the shock absorber tube, but has a matrix that does not reach as far as the surface of the interior of the shock absorber tube at a constant composite fraction of epoxide. The epoxide present over the entire thickness of the shock absorber tube wall can be materially uniform, and the coating comprised of additional epoxide extends inwardly beyond the radially inner fiber position of the fiber component, which easily prevents the shock absorber piston from coming into contact with the fiber component of the fiber composite material. The 60% volumetric fraction of fiber here relates to the carbon fiber composite material without the coating, thereby yielding a residual volumetric fraction of 40% that is filled with the epoxide.

For example, the coating can feature a thickness of 10 μm to 200 μm, preferably of 20 μm to 150 μm, and especially preferably 30 μm to 100 μm, wherein in particular the coating can feature a surface roughness measuring less than a value of Rz10, in particular having a surface roughness of Rz5. The high surface quality on the inside of the shock absorber tube formed by the coating surface is generated by the high surface quality of a winding mandrel, for example onto which the coating can be applied before winding up the carbon fiber composite material. For example, if the coating, e.g., the epoxide, is wound onto the winding mandrel, the carbon fiber composite material can be wound onto the winding mandrel and subsequently cured. The high surface quality of the winding mandrel is here imparted to the inside of the shock absorber tube, and, for example at Rz5, is sufficient to guide the shock absorber piston in a smoothly sliding manner, without damage over the long-term use of the shock absorber.

It is especially advantageous to cure the coating and carbon fiber composite material in a joint, in particular thermal curing process. The carbon fiber composite material with the coating can be cured while arranged on the winding mandrel, and curing allows the carbon fiber composite material with the coating to slightly grow in diameter, so that the resultantly formed shock absorber tube can be easily removed from the winding mandrel. The curing process can be based on exposing the carbon fiber composite material with the coating to a specific temperature control regimen, wherein a curing process can also involve electromagnetic irradiation, for example UV-irradiation, or exposure to ultrasound.

In an advantageous further development of the shock absorber according to the invention, a connecting element for joining the shock absorber with a wheel carrier of the vehicle can be arranged on a first end side of the shock absorber tube, while a fastening element for guiding a piston rod through so as to form a seal can be arranged on the second end side of the shock absorber tube. The attachment between the connecting element and/or fastening element and the shock absorber tube can be established via an adhesive bond and/or by positively winding at least one portion of the connecting element and/or fastening element with the carbon fiber composite material. In another advantageous embodiment, the connecting element and/or fastening element on the respective end of the shock absorber tube can also be secured thereto by means of a positive connection, in particular in combination with an adhesive bond, so as to make the connection fluid tight. In one special advantage, the shock absorber tube features an inner and outer diameter that stays constant, in particular remaining invariable at the end sides, so that the shock absorber tube can be cut to the required length from a semi-finished tube.

The present invention is further geared toward using a tube made of carbon fiber composite material to form a shock absorber tube for a shock absorber, wherein at least one shock absorber piston is guided in the shock absorber tube in a sliding manner, and wherein the inside of the shock absorber tube features a coating made of epoxide, which forms the sliding partners for the shock absorber piston guided in the shock absorber tube. The invention here utilizes the idea of qualifying known tubes made of carbon fiber composite materials for use as a shock absorber tube, in particular by applying to the inside of the body formed by the carbon fiber composite material an epoxide coating, which comprises the sliding surface for the shock absorber piston guided in the shock absorber tube. The features and advantages of the shock absorber described above can be applied accordingly when using a tube made of carbon fiber composite material.

The present invention is further geared toward a method for manufacturing a shock absorber tube for a shock absorber, in which at least one shock absorber piston is guided in a sliding manner, wherein the method features at least the steps of providing a winding mandrel and at least one carbon fiber composite material web, winding the at least one carbon fiber composite material web onto the winding mandrel with at least one axial winding component in relation to the winding mandrel and at least one radial winding component to form a shock absorber tube, and curing the carbon fiber composite material. It is here provided that a coating comprised of an epoxide be arranged on the inside of the shock absorber.

According to a possible advantageous embodiment, the coating can be arranged on the inside of the shock absorber tube by applying the coating before starting to wind the carbon fiber composite material web onto the winding mandrel. The coating, specifically the epoxide, is then applied by brushing or spraying it onto the winding mandrel. The carbon fiber composite material web can subsequently be wound onto the winding mandrel, wherein the coating forms the arising inside of the shock absorber tube.

According to an alternative embodiment, the coating can be applied to the inside of the shock absorber tube after removing the shock absorber tube from the winding mandrel in an application step, for example sprayed on.

It is also advantageous for the at least one carbon fiber composite material web with at least one axial and at least one radial winding component to be wound onto the winding mandrel in its axial direction via a relative motion between the incoming carbon fiber composite material web and the winding mandrel. The axial and radial winding component can be aligned in the longitudinal direction of the shock absorber, in the circumferential direction of the shock absorber, or on any diagonal between the longitudinal direction and circumferential direction of the shock absorber. In particular, the carbon fiber composite material web can feature axial components, radial components and/or diagonal components in several positions, for example which are arranged in an alternating positional direction over the built-up thickness of the shock absorber tube.

A connecting element and/or fastening element can be arranged on or axially adjacent to the winding mandrel, wherein the at least one carbon fiber composite material web is wound onto the winding mandrel or onto at least one portion of the connecting element and/or fastening element. As a consequence, a positive connection can be established between the connecting element and/or fastening element, wherein the connecting element and/or fastening element is arranged on the winding mandrel in such a way, for example, that the carbon fiber composite material web can be wound onto the latter until over the connecting element and/or fastening element, so as to create a homogeneous tubular body to form the shock absorber tube.

Additional measures that improve the invention will be presented in more detail below in conjunction with the description of a common exemplary embodiment of the invention based on the figures. Shown on:

FIG. 1 is a cross sectional view depicting an exemplary embodiment of a shock absorber with the features of the present invention, and

FIG. 2 is a detailed view depicting a shock absorber with a shock absorber tube and a fastening element arranged on the end side of the shock absorber tube.

FIG. 1 presents a cross sectional view of a shock absorber 1 for a vehicle, wherein the depiction of the shock absorber 1 is abstracted, and hence simplified. The shock absorber 1 features a shock absorber tube 10, and a shock absorber piston 11 is guided in the shock absorber tube so that it can longitudinally move along the longitudinal axis 17 of the shock absorber 1. Situated on the shock absorber piston 11 is a piston rod 16, and the piston rod 16 is guided in a fluid-tight manner out of a fastening element 15, which closes off the end side of the shock absorber tube 10.

The shock absorber tube 10 is comprised of a carbon fiber composite material, and the inside 12 has applied to it a coating 13, which forms the sliding partner for the shock absorber piston 11 guided in the shock absorber tube 10. The coating 13 covers the inside 12 over the entire length of the shock absorber tube 10, so that the coating 13 comprises the sliding partner of the shock absorber piston 11 over the entire stroke length of the shock absorber 1. The coating 13 is made of an epoxide, which can be the same epoxide as the epoxide that forms the carbon fiber composite material.

The thickness of the coating 13 features a thickness of 30 μm to 10 μm, and the surface roughness measures Rz5, thereby enabling a durable stroke movement that facilitates sliding for the shock absorber piston 11 in the shock absorber tube 10.

The coating 13 is thermally cured together with the carbon fiber composite material of the shock absorber tube 10, and the epoxide of the coating 13 forms in a materially uniform manner with the epoxide of the carbon fiber composite material.

The fastening element 15 is provided with a sealing element 18, so that the fastening element 15 is arranged in the shock absorber tube 10 in a fluid-tight manner. Situated around the fastening element 15 is an annular element 19, which features a conical segment 20 corresponding with a conical end of the shock absorber tube 10 manufactured out of the carbon fiber composite material. If the annular element 19 with the conical segment 20 is arranged over the end of the shock absorber tube 10, the annular element 19 can be adhesively bonded with the shock absorber tube 10, as a result of which the fastening element 15 is simultaneously rigidly secured at the end of the shock absorber tube 10. The sealing element 18 here forms a seal against the coating 13 of the inside 12 of the shock absorber tube 10. The side of the shock absorber tube 10 opposite the fastening element 15 features a connecting element 14, which also is adhesively bonded with the end side of the shock absorber tube 10 via a conical segment 21. The connecting element 14 incorporates another sealing element 19, which also forms a seal against the coating 13 on the inside 12 of the shock absorber tube 10. The connecting element 14 features a connecting lug 22, with which the shock absorber 1 can be joined with the wheel carrier of the vehicle.

The shock absorber tube 10 is manufactured out of a carbon fiber composite material, and the carbon fiber composite material is fabricated in a procedure in which a carbon fiber composite material web is wound in different winding directions 23, which are denoted by example with their direction of movement in the shock absorber tube 10. The winding directions 23 can feature a radial winding component 24 in the circumferential direction, an axial winding component 25 in the longitudinal direction, and various diagonal winding components 26. The diagonal winding components 26 can here run at any angle between the radial winding component 24 and the axial winding component 25. Only when various winding components 24, 25 and/or 26 are superposed to form the shock absorber tube 10 can the latter be designed with strength characteristics good enough to qualify a shock absorber tube 10 made of a carbon fiber composite material for use in forming a shock absorber 1.

FIG. 2 presents a detailed view of the shock absorber 1 with the shock absorber tube 10 in the area of the fastening element 18. The fastening element 15 is secured with an insert element 27 in the shock absorber tube 10 made of the carbon fiber composite material, and the carbon fiber composite material encompasses the insert element 27 in an enveloping angular segment 28, so that the insert element 27 becomes permanently situated in the shock absorber tube 10. On the inside 12 of the shock absorber tube 10, the coating 13 is not shown to scale in terms of its arrangement, and used for the axial sliding of the shock absorber piston 11 with the positioned piston rod 16.

Shown as a result is another exemplary embodiment for manufacturing the shock absorber tube 10 that is not cut to size from a semi-finished tube, after the latter has been wound onto a winding mandrel and coated on the inside with the coating 13, and the shock absorber tube 10 is wound onto the winding mandrel together with the insert element 27. In this case, the webs of the carbon fiber composite material extend over both the winding mandrel (not shown in any greater detail) and the insert element 27. After the winding mandrel has been removed, the insert element 27 in the arrangement remains in the shock absorber tube 10, and is secured therein by the enveloping winding segment 28.

The invention is not limited in its implementation to the preferred exemplary embodiment indicated above. Rather, a number of variants is conceivable, which make use of the described solution even given embodiments with a fundamentally different configuration. All features and/or advantages arising from the claims, specification or drawings, including structural details, spatial arrangements and procedural steps, can be essential to the invention, whether taken separately or in a wide range of combinations.

### REFERENCE LIST

1 Shock absorber
10 Shock absorber tube
11 Shock absorber piston
12 Inside
13 Coating
14 Connecting element
15 Fastening element
16 Piston rod
17 Longitudinal axis
18 Sealing element
19 Annular element
20 Conical segment
21 Conical segment
22 Connecting lug
23 Winding direction
24 Radial winding component
25 Axial winding component
26 Diagonal winding component
27 Insert element
28 Enveloping winding segment

1-12. (canceled)

13. A shock absorber for a vehicle, comprising:
at least one shock absorber piston;
a shock absorber tube, said at least one shock absorber piston being guided in a sliding manner in said shock absorber tube, said shock absorber tube formed of a carbon fiber composite material and having an inner side; and
a coating disposed on said inner side of said shock absorber tube, said coating forming a sliding partner for said shock absorber piston guided in said shock absorber tube, said coating formed of an epoxide.

14. The shock absorber according to claim 13, wherein said carbon fiber composite material includes a matrix comprised of epoxide, said epoxide forming said coating is identical to said epoxide forming said matrix, and said carbon fiber composite material features a 60% volumetric fraction of fiber.

15. The shock absorber according to claim 13, wherein said coating has a thickness of 10 μm to 200 μm and/or a surface roughness measuring less than a value of Rz10.

16. The shock absorber according to claim 13, wherein said coating and said carbon fiber composite material are cured in a joint, thermal curing process.

17. The shock absorber according to claim 13, further comprising:
a connecting element for joining the shock absorber with a wheel carrier of the vehicle, said connecting element disposed on a first end side of said shock absorber tube;
a piston rod; and
a fastening element for guiding said piston rod through so as to form a seal, said fastening element disposed on a second end side of said shock absorber tube, wherein an attachment between said connecting element and/or said fastening element and said shock absorber tube is established via an adhesive bond and/or by positively winding at least one portion of said connecting element and/or said fastening element with said carbon fiber composite material.

18. The shock absorber according to claim 13, wherein said coating has a thickness of 20 μm to 150 μm and/or a surface roughness measuring Rz5.

19. The shock absorber according to claim 13, wherein said coating has a thickness of 30 μm to 100 μm.

20. A method for forming a shock absorber, which comprises the steps of:
forming a carbon fiber composite material into a shock absorber tube;
guiding at least one shock absorber piston in the shock absorber tube in a sliding manner; and
providing an inner side of the shock absorber tube with a coating made of epoxide, the coating forming a sliding partner for the shock absorber piston guided in the shock absorber tube.

21. A method for manufacturing a shock absorber tube for a shock absorber, at least one shock absorber piston being guided in a sliding manner in the shock absorber tube, which comprises the steps of:
providing a winding mandrel and at least one carbon fiber composite material web;
winding the at least one carbon fiber composite material web onto the winding mandrel with at least one axial winding component in relation to the winding mandrel and at least one radial winding component to form the shock absorber tube;
curing the carbon fiber composite material; and
disposing a coating containing an epoxide on an inner side of the shock absorber tube.

22. The method according to claim 21, wherein the coating is disposed on the inner side of the shock absorber tube by applying the coating onto the winding mandrel, and then winding the carbon fiber composite material web onto the coating.

23. The method according to claim 21, which further comprises applying the coating to the inner side of the shock absorber tube after the shock absorber tube has been removed from the winding mandrel in an application step.

24. The method according to claim 21, which further comprises winding the at least one carbon fiber composite material web with the at least one axial winding component and the at least one radial winding component onto the winding mandrel in an axial direction via a relative motion between the incoming carbon fiber composite material web and the winding mandrel.

25. The method according to claim 21, which further comprises disposing a connecting element and/or a fastening element on or axially adjacent to the winding mandrel, wherein the at least one carbon fiber composite material web is wound onto the winding mandrel and onto at least one portion of the connecting element and/or the fastening element.
